(19) United States
(12) Patent Application Publication
(10) Pub. No.: US 2007/0209701 A1
(43) Pub. Date: Sep. 13, 2007

(54) PORTABLE PEDESTAL AIR FILTERING DEVICE

(75) Inventors: William E. Lasko, Chester Springs, PA (US); Paul W. Orr, Coatesville, PA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Lasko Holdings, Inc., Wilmington, DE (US)

(21) Appl. No.: 11/617,141

(22) Filed: Dec. 28, 2006

Related U.S. Application Data
(63) Continuation-in-part of application No. 10/855,697, filed on May 27, 2004, now Pat. No. 7,158,716.
Application No. 10/855,697 is a continuation-in-part of application No. 10/720,374, filed on Nov. 24, 2003, now Pat. No. 6,997,680.
Application No. 10/720,374 is a continuation-in-part of application No. 10/431,964, filed on May 8, 2003, now Pat. No. 6,942,456.
Application No. 10/431,964 is a continuation-in-part of application No. 10/347,079, filed on Jan. 17, 2003, now abandoned.
Application No. 10/347,079 is a continuation-in-part of application No. 10/322,169, filed on Dec. 18, 2002, now Pat. No. 6,760,543.

(51) Int. Cl. B03C 3/01; B08B 7/00

(52) U.S. Cl. 137/15.01; 96/108; 96/55

(57) ABSTRACT

A portable pedestal air filtering device is provided. The device includes a filtered air generation head, a support riser for supporting the filtered air generation head at an elevation above a support surface.

### CROSS-REFERENCE APPLICATIONS

This application is a Continuation-in-Part of application Ser. No. 10/855,697, filed May 27, 2004, which is a Continuation-in-Part of application Ser. No. 10/720,374, filed Nov. 24, 2003 (now U.S. Pat. No. 6,997,680), which is a Continuation-in-Part of application Ser. No. 10/431,964, filed May 8, 2003 (now U.S. Pat. 6,942,456), which is a Continuation-in-Part of application Ser. No. 10/347,079, filed Jan. 17, 2003 (now abandoned), which is a Continuation-in-Part of application Ser. No. 10/322,169, filed Dec. 18, 2002 (now U.S. Pat. No. 6,760,543).

### TECHNOLOGY FIELD

This invention relates generally to filters. More specifically, the present invention relates to a pedestal air filtering device in which exhaust air is filtered as it passes through a filter element.

### BACKGROUND

Portable air filtering devices have been utilized for many years. Conventional portable air filtering devices for consumer use typically include a filter and a fan within a housing. Ambient air is forced to pass through the filter in an attempt to clean the air.

Conventional air filtration devices however have several disadvantages. For example, conventional portable air filtration devices have air intake openings close to a support surface, such as for example, the floor. The low elevation of the air intake serves to draw particles that have already settled out of the air onto the floor into the filter. These particles tend to impede air passage through the filter which in turn requires that the filter be cleaned or replaced with greater frequency.

In a similar manner conventional portable air filtration devices also have an air outlet opening close to the floor. The low elevation of the air outlet opening also increases the possibility that the exhaust air stream produced by the device will disturbed to airborne substances such as dust, pollen or dander that had previously settled onto the floor. These substances can be detrimental to, for example, respiratory conditions.

Likewise, the substances that are disturbed to airborne by the low elevation of the air outlet opening may circulate into the air intake openings. These additional substances in the air, as they are removed from the air stream by the filter, further impede the passage of air through the filter, thus exacerbating the problem associated with filter maintenance.

These problems associated with conventional air filtering devices more rapidly degrade the performance of the filtering device, degrade the comfort level for consumers, and add additional filter maintenance time and filter replacement costs. In light of the aforementioned problems, there is a need for a portable air filtration device having both an air intake opening and an air exhaust opening elevated above the floor. Ideally, this device will reduce the recirculation of sediment from the floor to the filter. The device will also preferably have a vertical aspect ratio and air flow characteristics to efficiently circulate and filter air within a room.

### SUMMARY

In view of the shortcomings of the prior art the present invention is a portable pedestal air filtering apparatus for providing a filtered exhaust air stream at an elevation above a support surface.

According to an aspect of the present invention, the portable pedestal air filtering apparatus includes a filtered air generation head supported by a riser at an elevation above a support surface.

According to another aspect of the invention, the filtered air generation head includes an elongate housing having at least one sidewall, a top end, a bottom end, and a longitudinal length extending upward.

According to another aspect of the invention, the elongate housing defines an interior space having an inlet opening allowing inlet air to enter the interior space.

According to another aspect of the invention, the elongate housing defines an interior space having an air outlet opening allowing filtered air to exit the interior space.

According to yet another aspect of the invention, an air blower is disposed within the interior space for receiving inlet air and generating an exhaust air stream.

According to another aspect of the invention, a filter element is disposed such that substantially all of the intake air and/or the exhaust air stream passing through said interior space passes through the filter element and is projected from the housing as a filtered exhaust air stream.

According to another aspect of the invention, the support riser supports the filtered air generation head and includes a base and a riser. The riser may include a first end connected to the base, a longitudinal length extending substantially upward from the base, and a second end connected to the filtered air generation head.

According to another aspect of the invention, an elevation of the filtered exhaust air stream is defined by the distance from where the support riser contacts the floor to a vertical midpoint of the air outlet opening of the filtered air generation head. The elevation of the filtered exhaust air stream reduces the recirculation of sediment from the floor to the filter and reduces the need to replace or maintain the filter.

According to another aspect of the invention, the vertical aspect ratio of the portable pedestal air filtering apparatus in combination with the elevated filtered exhaust air stream and the elevated inlet opening increase the comfort level for consumers and the efficiency of operation of the device.

Additional features and advantages of the invention will be made apparent from the following detailed description of illustrative embodiments that proceeds with reference to the accompanying drawings.

### BRIEF DESCRIPTION OF THE DRAWINGS

The invention is best understood from the following detailed description when read in connection with the accompanying drawing. It is emphasized that, according to common practice, various features of the drawings are not to scale. On the contrary, the dimensions of various features are arbitrarily expanded or reduced for clarity. Included in the drawings are the following figures:

FIG. 1 is a perspective view of an exemplary embodiment of the portable pedestal electric heater of the present invention;

FIG. 2 is an exploded view of the exemplary embodiment of FIG. 1;

FIG. 3A and 3B illustrate the dimensional aspects of exemplary heating elements;

FIGS. 4A and 4B are front and top views, respectively, of an exemplary embodiment of the portable pedestal electric heater illustrating various dimensional relationships of the cooperating elements;

FIG. 5 is a perspective view of another exemplary embodiment of the portable pedestal electric heater with an adjustable height feature;

FIG. 6 is a partial section showing another exemplary embodiment of the portable pedestal electric heater of the present invention;

FIGS. 7A and 7B illustrate the elevated heated exhaust air stream of a portable pedestal electric heater according to the present invention compared to a conventional heater;

FIGS. 8A, 8B, 8C and 8D are views of exemplary packaging according the present invention;

FIGS. 9A, 9B and 9C are views of yet another exemplary embodiment of the present invention and illustrates exemplary packaging of that embodiment;

FIGS. 10A, 10B and 10C are views of yet another exemplary embodiment of the present invention and illustrates exemplary packaging of that embodiment.

FIG. 11 shows an exploded perspective view of an embodiment of a portable pedestal air filtering device;

FIGS. 12A and 12B show vertical and horizontal cross sectional view through another embodiment of a portable pedestal air filtering device;

FIG. 13 shows an exemplary embodiment of a portable pedestal air filtering device illustrating various dimensional relationships of the cooperating elements; and

FIG. 14 shows an embodiment of an electrostatic air filter.

### DETAILED DESCRIPTION OF THE INVENTION

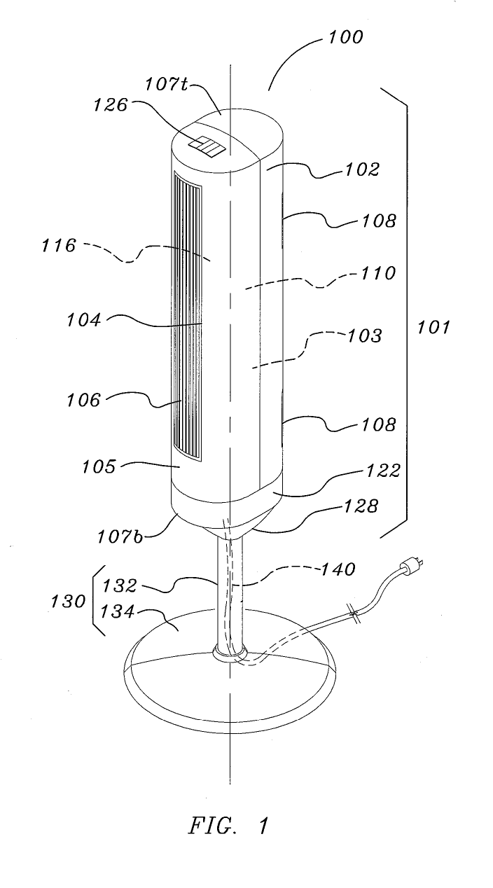

The following description is of a pedestal electric heater 100 that is preferably portable (e.g., free standing and easily movable). Referring now to FIG. 1, portable pedestal electric heater 100 includes a tower electric heater 101 and a support riser 130. The tower electric heater 101 includes an elongated housing 102 having a vertical aspect ratio, a heating element or elements 116, and an air blower assembly 110 for providing a heated exhaust air stream at a height above a support surface. The riser support 130 includes a base 134 and a riser 132 for further positioning the heated exhaust air stream at a height above a support surface, thereby allowing the generated heat to more immediately effect a portion of the user's upper body.

The combination of a tower type electric heater 101 mounted on top of a vertical support riser 130 shortens the heat path between the heating element and an upper portion of the user's body. Since the heat source is further elevated above a support surface and is more closely related to an upper portion of the body, the heat effect to the user is more direct and immediate.

The use of a tower electric heater 101 in conjunction with a support riser 130 to further elevate the heated exhaust air stream allows for flexibility in design of the individual components of the portable electric heater 100 while also providing for cost efficiency. For example, the length of the tower electric heater 101 and the length of the support riser 130 can be manipulated as desired for any particular application in order to obtain the desired heating design characteristics while also minimizing manufacturing cost. By using a support riser, the desired heating characteristics can be achieved at an elevation above a support surface while still maintaining cost efficiency in, for example, the air blower assembly design and the electric heating element design.

The pedestal electric heater 100 having a tower electric heater 101 also provides a space saving design over conventional heater and provides for a lower center of gravity thereby improving stability and minimizing the size of the base required to maintain the pedestal electric heater 100 in an upright position and thus avoid tipping of the apparatus.

Additional details of the structure of the elongate housing having a vertical aspect ratio, the elongate heating element, and the blower assembly impeller design can be found in commonly assigned, application Ser. No. 10/322,169, filed Dec. 18, 2002, entitled “Electric Heater”, which is hereby incorporated by reference in its entirety.

Additional details of the structure of the support riser and the blower assembly impeller design can be found in commonly assigned, application Ser. No. 10/720,374, filed Nov. 24, 2003, entitled “home comfort device” and application Ser. No. 10/431,964, filed May 8, 2003 entitled “home comfort appliance” both of which are hereby incorporated by reference in their entirety.

Referring again to FIG. 1, housing 102 includes one or more sidewalls 105 extending between a bottom 107b and a top 107t thereby defining an interior space 103. Housing 102 includes an elongated construction, preferably extending vertically upward from the bottom 107b to the top 107t. This elongate construction of housing 102 results in tower electric heater 101 having a space savings design. Housing 102 also includes one or more air inlet openings 108 and an air outlet opening 104. Protective grill 106 is preferably disposed over air outlet 104 for preventing foreign objects from entering the interior space 103 of housing 102. Disposed within interior space 103 is air blower assembly 110 and electric heating element 1 16. Portable pedestal electric heater also includes support riser 130 having a base 134 and a riser 132. Pedestal electric heater 100 also includes power cord 140 and control assembly 126. Control assembly 126 controls one or more operations of portable pedestal electric heater 100.

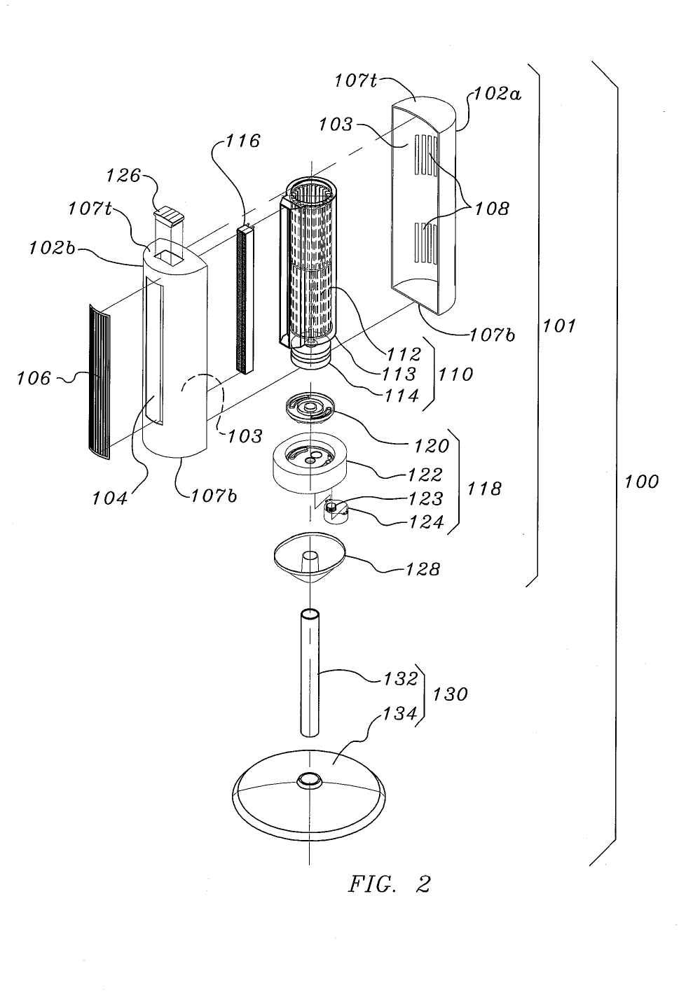

FIG. 2 shows an exploded perspective view of portable pedestal electric heater 100. As shown in FIG. 2, housing 102 may be constructed of more than one component, such as, for example, two halves 102a, 102b that are assembled together. Housing 102 has at least one air inlet opening 108 and an air outlet opening 104. Air outlet opening 104 may be, for example as shown in FIG. 2 elongate and aligned with the longitudinal length of housing 102 of portable pedestal electric heater 100.

Disposed within interior space 103 of housing 102 is at least one air blower assembly 110. Air blower assembly 110 includes at least one motor 114 and at least one air impeller 112 connected to motor 114. Air blower assembly 110 may also include, as in this example, blower housing 113 and other components (not shown). The use of air blower assembly 110 preferably allows for the pre-assembly and pre-testing of air blower assembly 110 thereby allowing the manufacture and assembly of portable pedestal electric heater 100 to be less costly when compared to assembling motor 114, air impeller 112 and blower housing 113 into portable pedestal electric heater 100 as separate components. In one embodiment, air blower assembly 110 is a centrifugal type blower. It is contemplated that other types of blowers or fans may be used, such as for example, transverse type blowers or axial type fan.

Also disposed within interior space 103, proximate air exit opening 104 is heating element 116. Preferably, substantially all of the air being discharged from air blower assembly 110 flows through heating element 116. It is contemplated that a portion of the air being discharged from air blower assembly 110 may bypass heating element 116. Such a bypass may be used to allow safety devices, such as for example a thermal cut off, (not shown) to function properly.

As shown in FIG. 2, in one embodiment heating element 116 includes an elongate electric heating element that is aligned with the longitudinal length of housing 102. In another embodiment, outlet opening 104 also includes an elongate construction and the elongate heating element 116 extends substantially the length of the air outlet opening 104. Use of an elongate electric heating element in conjunction with an elongate outlet opening 104 further allows the heated exhaust air stream to be elevated above a support surface, further facilitating a shorter convection path between the heating element and an upper portion of the user's body. In addition, an elongated construction for heating element 116 and outlet opening 104 also helps the heated exhaust air stream conform to the general shape of the user's upper body.

In one embodiment, heating element 116 uses a Positive Temperature Coefficient (PTC) type heat generation technology. The use of a PTC heating element assures a self-regulating low surface temperature of approximately 450 degrees Fahrenheit[232 degrees Celsius].

The rotation of air impeller 112 causes air to be drawn into housing 102 through air inlet opening(s) 108. The air flow passes through blower assembly 110, passes through heating element 116, and exits housing 102 through air outlet opening 104. As the air flow passed through heating element 116, thermal energy (i.e. heat) is imparted to the air flow.

Preferably, protective grill 106 is located proximate air outlet opening 104. Protective grill 106 is preferably designed to minimize it's impedance of the air flow as it exits portable pedestal electric heater 100 while at the same time protecting portable pedestal electric heater 100 from the internal penetration of foreign objects. Protective grill 106 may include air directing vanes that can be used to control the direction of the heated exhaust air stream as it exits housing 102.

Protective grill 106 may be, for example as shown in FIG. 2 elongate and aligned with the longitudinal length of housing 102 of pedestal electric heater 100. The purpose of the protective grill may include ornamental and/or functional characteristics as described above.

In one exemplary embodiment, an intermediate coupler 128 may be used to couple housing 102 to support column 130. Such a coupler 128 may be either fixed or rotatable. Alternatively, housing 102 may be coupled directly to support column 130 such that housing 102 is fixed with respect to support column 130.

In another exemplary embodiment, housing 102 rotates with respect to support column 130. Such rotation may be accomplished either in an oscillatory fashion (over any angular range that may be desired), a stepwise positioning of housing 102 (either manually or under automated control), or in a constant rotation, either in a clockwise or counter-clockwise direction. As shown, the mechanism for rotation may be located within or below housing 102 and coupled between housing 102 and support riser 130. In yet another embodiment the rotation mechanism may be located between base 134 and riser 132 of support riser 130.

FIG. 2 shows rotation/oscillation mechanism 118. Rotation/oscillation mechanism 118 moves housing 102 of portable pedestal electric heater 100 through rotation and/or oscillation movement. Such movement allows the heated exhaust air stream to be dispersed over a larger coverage area. As shown in FIG. 2, rotation/oscillation mechanism 118 includes a motor 124, gear 123, oscillation plate 120, and oscillation section 122. It is contemplated that other rotating mechanisms, such as a link and pivot design, may be used to achieve rotation/oscillation movement.

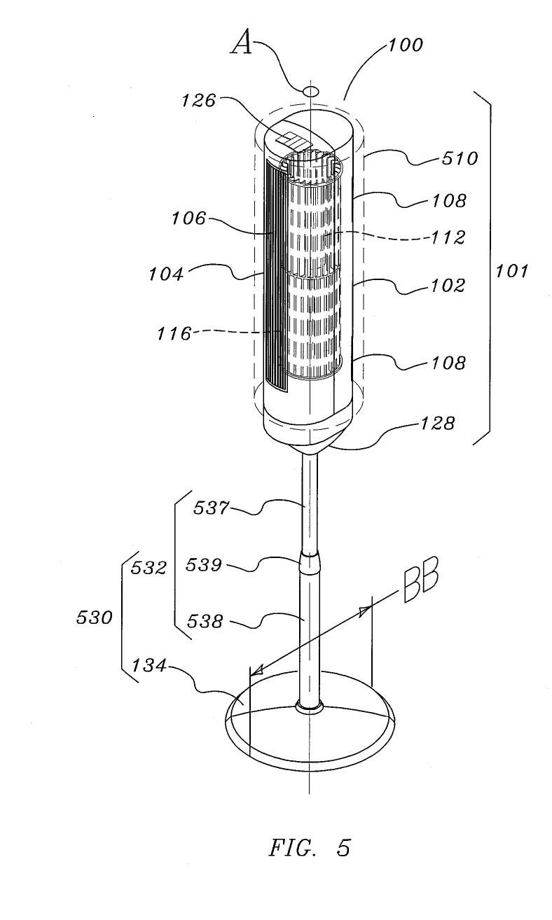

As shown, support riser 130 extends from housing 102 and includes riser 132 and base 134. Support riser 130 may be formed of metal, polymer or other materials. Riser 132 maybe comprised of more than one riser member thus allowing for height adjustability (best described with reference to FIG. 5). The upper portion of riser 132 is connected to coupler 128 or housing 102 and the lower portion of riser 132 is connected to base 134.

Base 134 may be comprised of one or multiple pieces attached to one another. Base 134 may be made of materials such as metals or polymers or a combination of various materials. Base 134 sits on a support surface thus allowing the entire structure of portable pedestal electric heater 100 to be positioned in a substantially vertical, upright and elongate position.

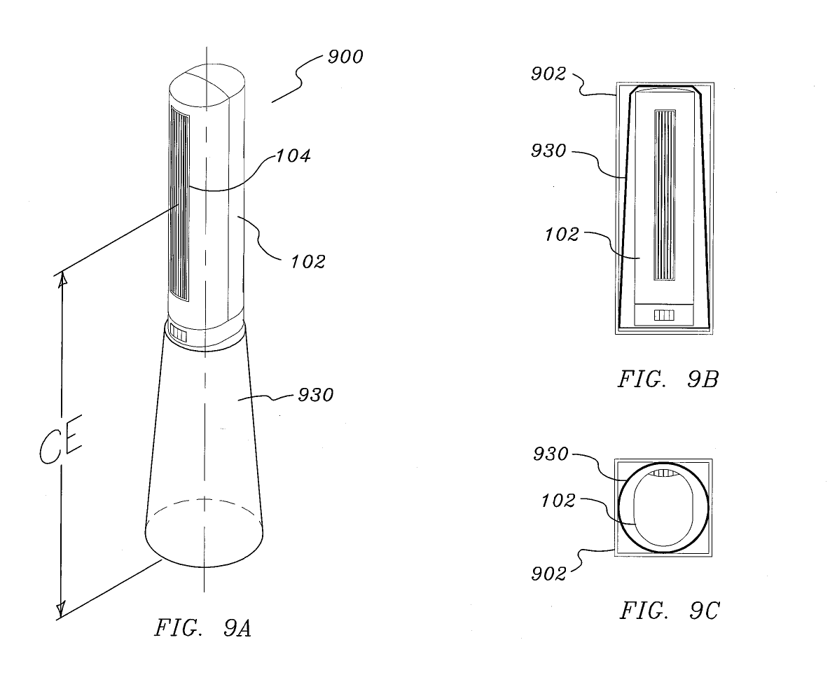

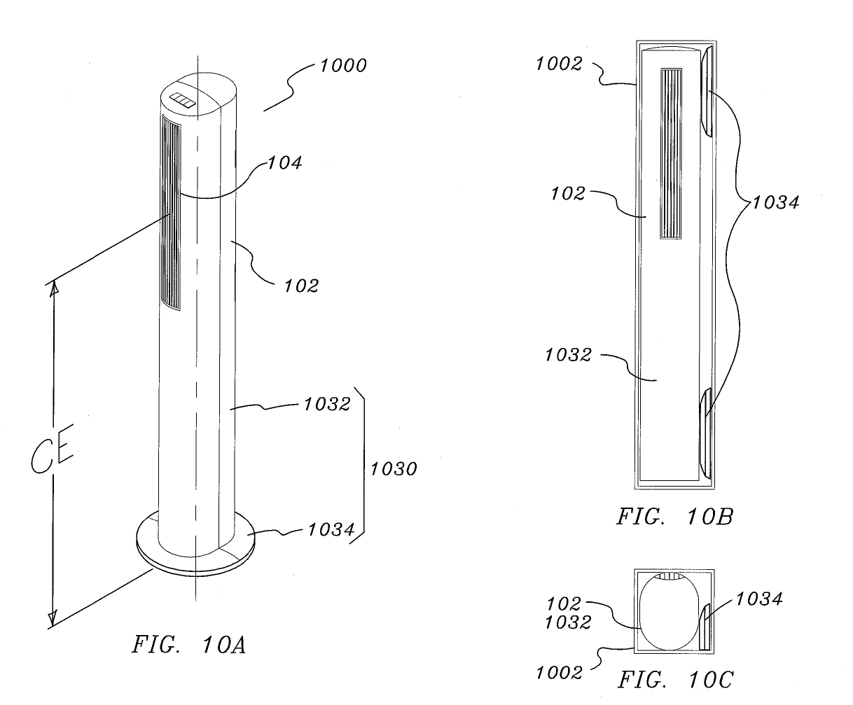

Although the exemplary embodiment shown in FIG. 2 illustrates support riser 130 including base 134 and riser 132 as separate pieces, the invention is not so limited. It is contemplated that the support of housing 102 may be accomplished in a variety of ways, such as forming support riser 130 as a unitary member having a variety of predetermined shapes. Other non-limiting examples of such shapes are shown in FIGS. 9 and 10. The vertical space created by support riser 130 between a support surface and the heated exhaust air stream as it exits housing 102 may be used for other functions, such as for example: mounting controls, humidification, air filtration, etc.

Portable pedestal electric heater 100 may also include a controller, such as control assembly 126 mounted, for example, on (or in the vicinity of) top 107t of housing 102 for controlling one or more functions of the device, such as for example, the speed of blower assembly 110, the rotation or oscillation of the device, power on/off, heat level, etc. Alternatively, control assembly 126 may be mounted in oscillation section 122, a lower portion of housing 102, on riser 132 or on base 134. Alternatively, control of portable pedestal electric heater 100 may be accomplished by a remote control unit (not shown) in conjunction with or as a replacement for control assembly 126.

The position of the control assembly 126 on top 107t of housing 102 on the substantially vertical, upright and elongate structure of portable pedestal electric heater 100 also benefits the user in that the height of the controller above a support surface (floor) allows convenient accessibility for visual inspection and manually adjustment of the controller.

Referring again to FIG. 1, the exemplary embodiment illustrates one method of routing power cord 140 from an electrical connection (not shown) in portable pedestal electric heater 100 through riser 132 and exiting base 134 at a lower portion of portable pedestal electric heater 100. The routing of power cord 140 through riser 132 prevents power cord 140 from becoming entangled in other components of portable pedestal electric heater 100 during oscillation. Alternatively, power cord 140 may exit through an opening in housing 102.

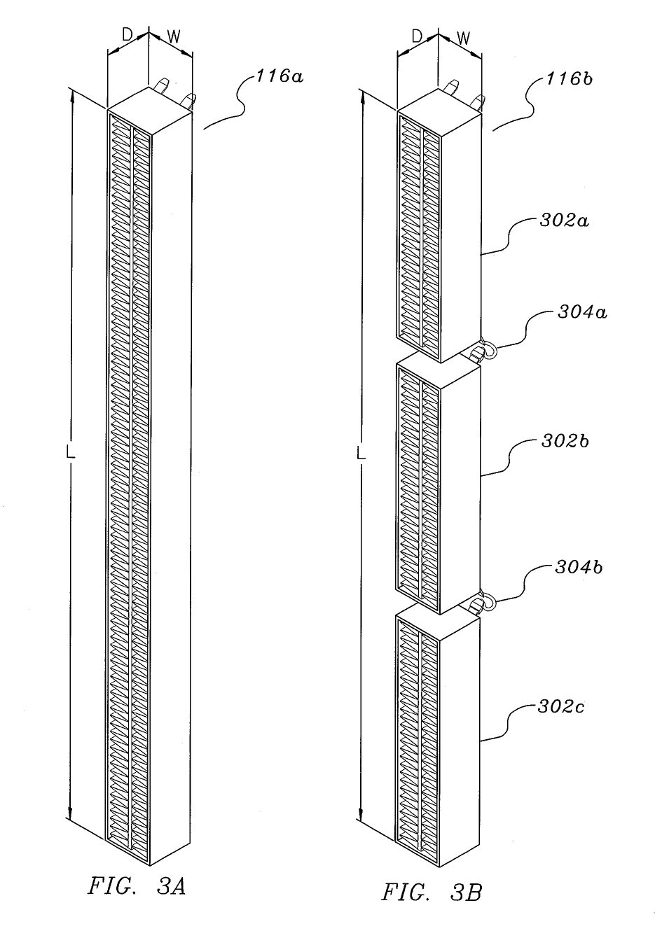

FIGS. 3A and 3B show exemplary embodiments of elongate heating element 116a and 116b. The heat generation method can be, for example, Positive Temperature Coefficient (PTC) heat generation technology. As shown in FIG. 3A, elongate heating element 116a is shown having a predetermined length “L”, in a vertical orientation, a predetermined width “W” and a predetermined depth “D”. The ratio of length “L” to width “W” is preferably greater than about 2:1. In one embodiment, the preferred predetermined length “L” of elongate heating element 116a is about 8 inches or greater. In yet another embodiment, the predetermined length “L” of elongate heating element 116a is about 5 inches or greater. The use of a single elongate heating element minimizes the number of connections and simplifies the design and assembly of the heating element 116.

FIG. 3B shows another exemplary embodiment of elongate heating element 116b. As shown in FIG. 3B, elongate heating element 116b may be constructed of one or more segments 302a, 302b, 302c. As shown, segments 302a, 302b and 302c are preferably arranged substantially contiguous and aligned end to end. The use of multiple segments 302a, 302b, 302c may require additional connections 304a and 304b between segments.

The use of a PTC elongate heating element, for example, requires that the length “L” to width “W” aspect ratio be designed to achieve the proper watt density and flow through characteristics. In general, as length “L” increases, the watt-density decreases, and cost increases for the same width heating element. For example, the use of a 1500 watt PTC elongate heating element limits length “L” of elongate heating element 116a or 116b, in that the watt density within the heating element will not heat the surfaces of heating element 116a or 116b efficiently if length “L” is too long. This inefficient heating will in turn create inefficient heating of the exhaust air stream. This design limitation on the length of the elongate heating element limits the elevation height of a conventional tower heater above a support surface (e.g., floor).

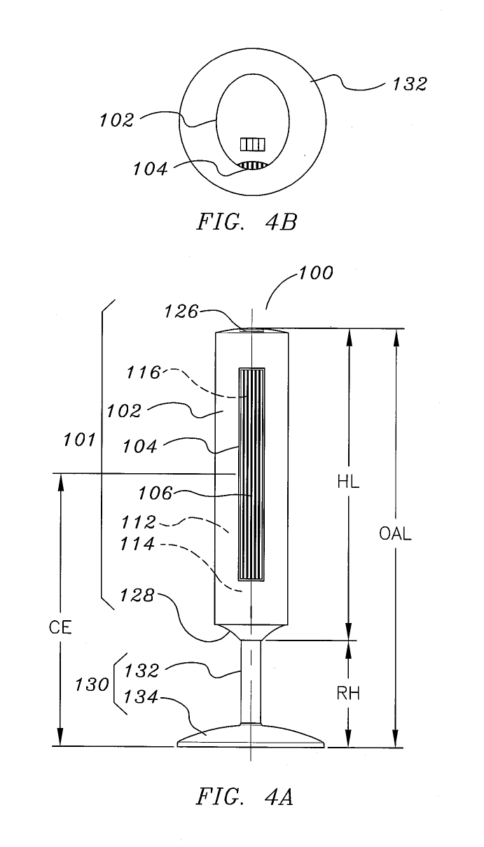

The use of a support riser 130 in pedestal electric heater 100 of the present invention is utilized to overcome this heating element design limitation (as well as other design consideration, as discussed below). Support riser 130 allows length “L” of elongate heating element 116a or 116b to be of a length so as to maintain the desired watt density while at the same time achieving the desired elevation of the heated exhaust air stream above a support surface. (see FIGS. 4A and 4B). It is preferred to maintain watt-density as high as possible because as watt-density increases the temperature of the heated exhaust air stream also increases (assuming a constant velocity through the heating element). In addition to improving the watt-density of the heating element, keeping the length “L” shorter also reduces the complexity and cost of the heating element 116. The use of support riser 130 to further elevate the heating element, and thus the heated exhaust air stream allows for the use of a shorter length “L” that might otherwise be possible to achieve the desired shortened flow path between the heating element and an upper portion of the user. This results in more cost efficient heating.

FIGS. 4A and 4B show various dimensional relationships of portable pedestal electric heater 100. As shown, dimension HL is the length or height of housing 102 and dimension RH is the length or height of support riser 130, which in this example is the combined length or height of base 134 and riser 132. Dimension OAL is defined by the length or height of portable pedestal electric heater 100 as measured from the bottom of support riser 130 to top of housing 102. Dimension CE is defined by the distance from the vertical center of air outlet opening 104 to a surface of support riser 130 which contacts a support surface.

The use of elongate housing 102 of tower electric heater 101 in conjunction with support riser 130 provides flexibility in the design and selection of different components of the device, such as the characteristics and type of air blower assembly 110 or heating element 116, and also allows the dimensions of elongate housing 102 and support riser 130 to be manipulated to obtain the desired height for optimizing the delivery of the heated exhaust air stream above a support surface. For example, increasing the length or height RH of the support riser 130 allows housing 102 to have a smaller length or height HL, thereby simplifying the design and manufacturing of air blower assembly 110 and heating element 116. This can save both materials and manufacturing complexity which in turn lowers the cost to the end user.

In one embodiment rise height RH is greater than about 25% of dimension CE. In addition, in another embodiment rise height RH is greater than about 15% of overall length OAL of portable pedestal electric heater 100. In yet another embodiment, rise height RH is greater than about 16% of length HL of housing 102. In another embodiment, length HL of housing 102 is less than about 85% of overall length OAL

In one embodiment dimension CE is greater than about 65% of overall length OAL. In yet another embodiment dimension CE is greater than about 70% of length HL.

In one exemplary embodiment dimension CE is preferably about 14 inches or greater. In another exemplary embodiment, rise height RH is at least about 3.5 inches or greater and may be adjustable as desired. Further, length HL of housing 102 may preferably be between about 14 inches and about 50 inches, while the overall length OAL from the floor to the top of portable pedestal electric heater 100 is preferably about 18 inches or greater, and alternatively between about 18 inches to about 60 inches.

The above dimensional relationships of portable pedestal electric heater 100 allow for elevating the heated exhaust air stream, thus shortening the heat path and promoting the desired effect on the user. These proportional relationships also provide that the length of air impeller 112 will be of a dimension allowing cost effective manufacturing, while yet providing portable pedestal electric heater 100 with the desired vertical elongate aspect ratio. The length of air impeller 112 would also require less power to rotate than a longer air impeller, thus allowing motor 114 to use less materials and be more cost effective. These proportional relationships also provide that heating element 116 will have the desired watt density to efficiently heat the exhaust air stream while yet providing the desired vertical elongate aspect ratio and space saving characteristics, best described with respect to FIG. 5.

FIG. 5 shows an exemplary embodiment of the portable pedestal electric heater 100 having an adjustable support column 532. As shown, adjustable support column 532 includes a plurality of cooperating columns 537, 538. In the embodiment shown, the cooperating columns include upper column 537 slideably connected to lower column 538 with adjustable coupler 539 there between. In the lower most position, upper column 537 fits substantially within lower column 538. Adjustable coupler 539 allows movement of the columns with respect to one another to adjust the height of support riser 130 and also allows for fixing the columns with respect to one another to set the height of support riser 130. In this example the overall height of portable pedestal electric heater 100 can be adjusted to allow the user more flexibility regarding the elevation of the heated exhaust air stream above floor level. Additional columns and couplers (not shown) may be used as required.

FIG. 5 also illustrates that the rotational axis of oscillation of housing 102 is preferably substantially co-linear with central axis “A” of portable pedestal electric heater 100. The vertical aspect ratio of housing 102 allows oscillation envelope 510 to be distributed along central axis “A”. Oscillation envelope 510 is defined as the area of movement of housing 102 about the rotational axis of oscillation. The axis of rotation of air impeller 112 of air blower assembly 110 within interior space 103 of housing 102 is preferably oriented vertically and substantially co-linear with central axis “A” of portable pedestal electric heater 100. This reduces the effects of gyroscopic precession during the oscillation of housing 102 and increases the stability of portable pedestal electric heater 100.

In one exemplary embodiment oscillation envelope 510 is substantially equal to a maximum width of a horizontal cross-sectional area of housing 102. In another exemplary embodiment the maximum width of a horizontal cross-sectional area of housing 102 is about 12 inches or less. In yet another embodiment the ratio of the length dimension HL of housing 102 to a maximum width of a horizontal cross-sectional area of housing 102 is less than about 1.5:1.

In one exemplary embodiment air impeller 112 has a predetermined diameter and a predetermined length to allow air impeller 112 to have an elongated aspect ratio. In one embodiment the predetermined length to the predetermined diameter aspect ratio of impeller 112 is greater than about 2:1. Maintaining the elongated aspect ratio of air impeller 112 allows it to fit within elongate housing 102 of pedestal electric heater 100.

In one embodiment air impeller 112 is a limited volume impeller. For example, the velocity of the heated exhaust air stream is preferably fixed to effectively reach the user. The desired temperature of the heated exhaust air stream is also preferably fixed to deliver an adequate temperature differential between the ambient air temperature and the temperature of the heated exhaust air stream. Elongate heating element 116 may be for example a PTC heating element with a fixed maximum wattage of 1500 W. This fixed wattage requirement along with the fixed temperature and velocity requirements of the heated exhaust air stream determines a fixed watt density requirement of elongate heating element 116. The fixed watt density requirement of elongate heating element 116 is achieved by the proper ratio of length “L” to width “W” of elongate heating element 116. Thus the area of elongate heating element 116 is preferably fixed to have the desired watt density to sufficiently heat the heated exhaust air stream to the desired temperature. Air flow through the heating element may be stated:
Q/A=V

Where: Q is the volume, (cubic feet per minute) of air flowing through elongate heating element 116, A is the area of elongate heating element 116 and V is the desired velocity of the heated exhaust air stream. The volume of air Q is preferably sufficiently limited for the desired velocity V to be achieved while not exceeding the 1500 watt output desired for elongate heating element 116.

An effective way to limit volume Q of impeller 112 is to reduce its diameter. The limited diameter of impeller 112 also more easily fits within elongate housing 102 of pedestal electric heater 100, thus maintaining the desired vertical aspect ratio.

The vertical aspect ratio of housing 102, allows the oscillating components of portable pedestal electric heater 100 to be substantially on center with support riser 530 along central axis “A” thus increasing the stability of portable pedestal electric heater 100.

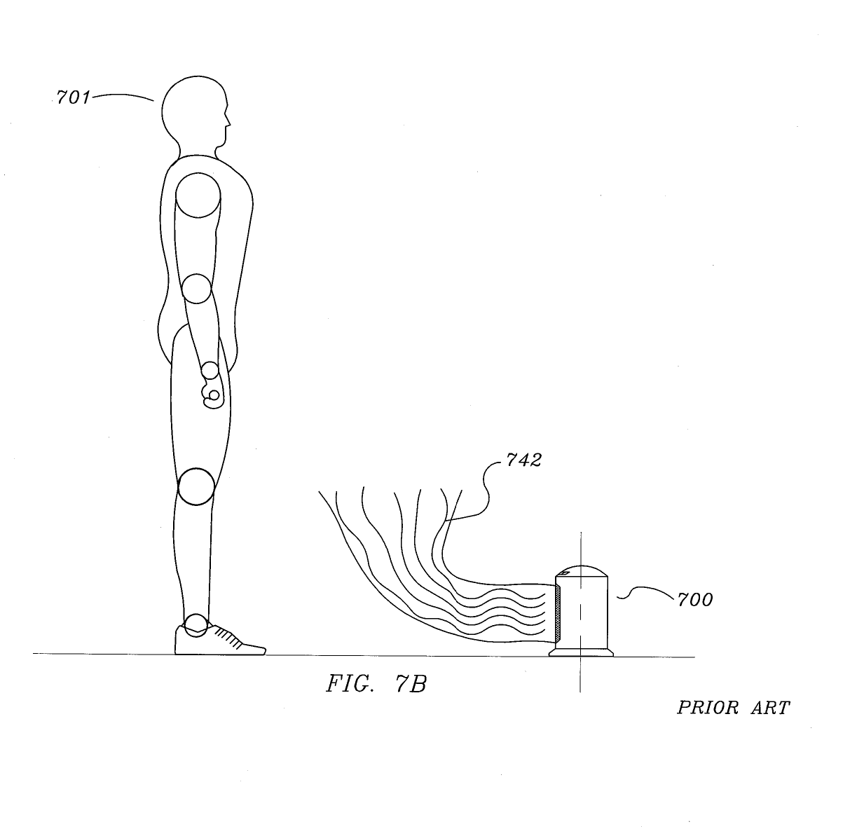

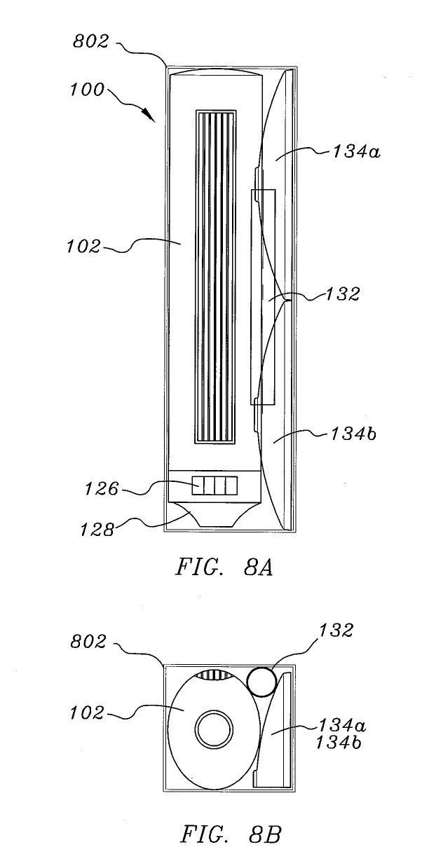

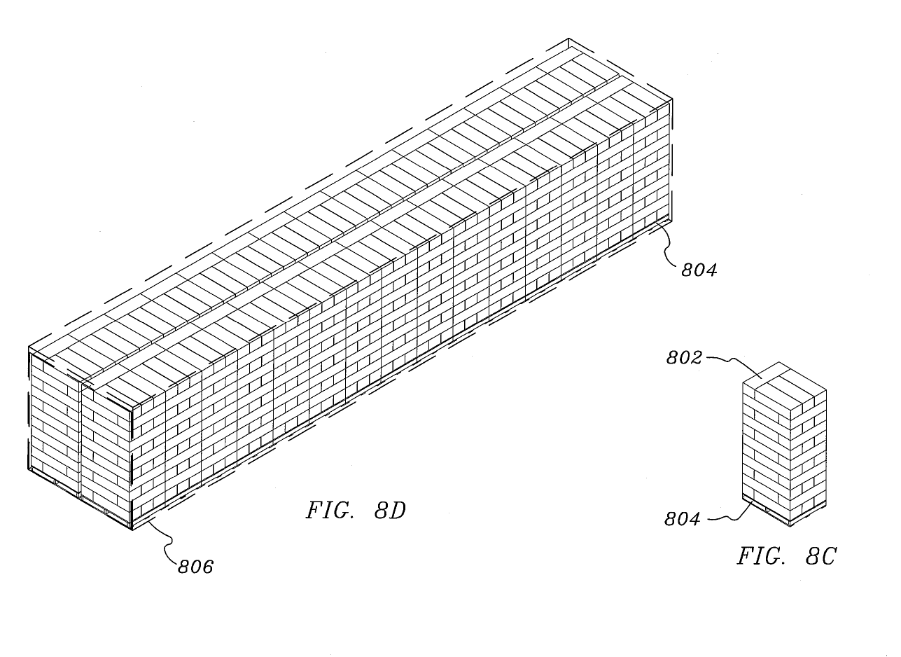

The substantially vertical, upright and elongate structure of portable pedestal electric heater 100, (which includes the vertical aspect ratio of housing 102 and preferably includes an elongate heating element 116) helps to minimizes the vertical distance above a support surface, (floor) to the center of gravity of portable pedestal electric heater 100. This structure, along with substantially centering the oscillating components on support riser 530 along central axis “A”, coupled with the reduced effects of gyroscopic precession during oscillation, increase the stability of portable pedestal electric heater 100. This increased stability allows dimension BB of base 134 to be minimized. The minimized dimension BB of base 134 allows portable pedestal electric heater 100 to have further space saving characteristics and, to be easily transported from place to place within a living space or between various living spaces as desired. The minimized dimension BB of base 134 also allows an economization of the size of a shipping package for portable pedestal electric heater 100. The economization of the size of a shipping package allows more units to be shipped in a container, (i.e. truck) and thereby reduces the overall cost per unit of transportation, (see FIGS. 8A, 8B and 8C).

Dimension BB of base 134 is equal to the maximum width of a horizontal cross-sectional area of base 134. In another exemplary embodiment dimension BB of base 134 is about 18 inches or less for a portable pedestal electric heater 100 having housing 102 with a maximum width of a horizontal cross-sectional area of about 12 inches or less. In yet another exemplary embodiment the maximum width of a horizontal cross-sectional area of housing 102 is less than about 70% of dimension BB.

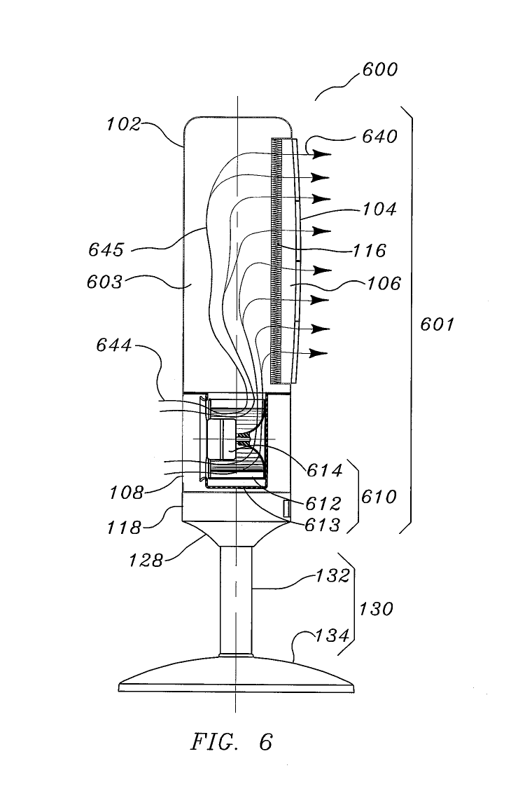

FIG. 6 shows another exemplary embodiment of the portable pedestal electric heater. FIG. 6 illustrates a partial cross sectional side view through portable pedestal electric heater 600. Portable pedestal electric heater 600 is comprised of housing 102 defining interior space 603. Within interior space 603 is disposed heating element 116 and blower assembly 610. Blower assembly 610, in this example, includes motor 614, air impeller 612 and blower housing 613. In this example, air impeller 612 is a centrifugal blower type impeller.

Air 644 is drawn into blower assembly 610 through at least one inlet opening 108 in housing 102. Exhaust air 645 is discharged from blower assembly 610 into interior space 603 of housing 102. Exhaust air 645 then passes through elongate heating element 116 and is discharged from portable pedestal electric heater 600 as heated exhaust air stream 640. Heating element 116 is located proximate air exit opening 104. Also located proximate air exit opening 104 is protective grill 106.

The location of blower assembly 610 in the lower portion of housing 102 lowers the center of gravity of portable pedestal electric heater 600 in that the weight of motor 614, impeller 612 and blower housing 613 are low with respect to the bottom of support riser 130. This increases the stability of portable pedestal electric heater 600 and allows for the desired vertical elongate aspect ratio, increased height of the heated exhaust air stream, and space saving characteristics.

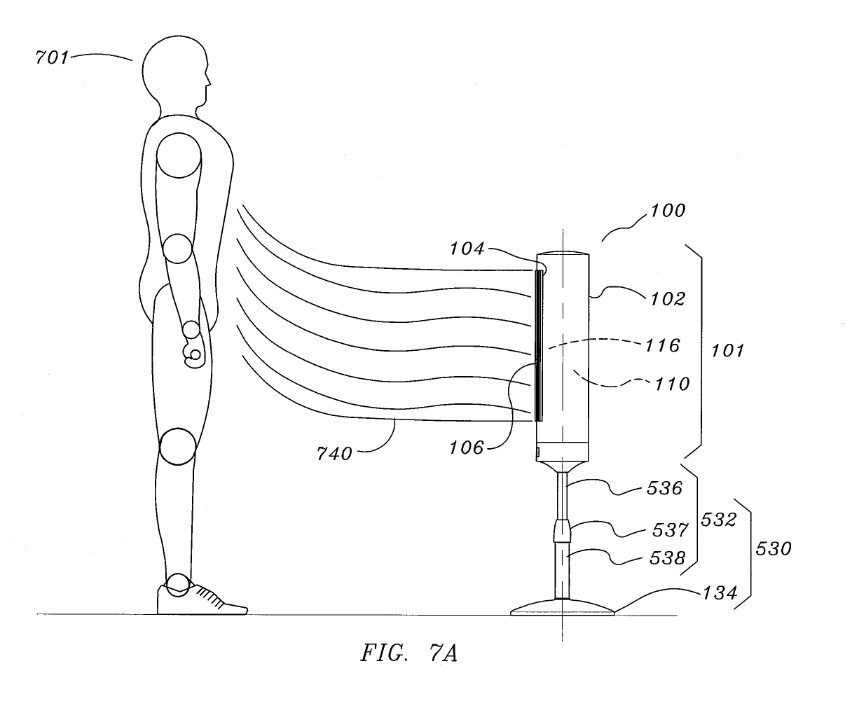

FIGS. 7A and 7B illustrate the advantages of the pedestal electric heater of the present invention when compared to a standard portable electric heater design. FIG. 7A shows an exemplary embodiment of the present invention and FIG. 7B illustrates standard portable electric heater 700. As shown in FIG. 7B, heated exhaust air stream 742 exits standard portable electric heater 700 at a low elevation. This low elevation increases the distance that the heat must traverse to reach an upper portion of user 701.

In contrast, FIG. 7A illustrates the improved performance characteristics of portable pedestal electric heater 100 in accordance with the present invention. Heated exhaust air steam 740 exits portable pedestal electric heater 100 at an elevation that shortens the distance that must be traversed by heated exhaust air stream 740 in order to effect an upper potion of user 701. The upper portion of user 701 is normally more exposed and therefore will experience the effects of heated exhaust air stream 740 more readily, contributing to the more immediate relief of user 701.

The substantially vertical, upright and elongate structure of portable pedestal electric heater 100 also benefits user 701 in that the shape of heated exhaust air stream 740 may be elongate and vertical as it exits housing 102. An elongate and vertical shape of heated exhaust air stream 740 generally conforms to the human body.

FIGS. 8A, 8B, 8C, and 8D illustrate another advantage realized with respect to packaging and shipment of the exemplary design of the portable pedestal electric heater 100 of the present invention. As shown in FIGS. 8A and 8B, portable pedestal electric heater 100 is packaged in a non-operating configuration, wherein housing 102 is separated from riser 132 and base 134. In this example base 134 is designed to be separate from riser 132 and further disassemble into one or more portions, such as portions 134a and 134b. Shipping box 802 is therefore able to economize the space necessary to transport portable pedestal electric heater 100, thus using less packaging materials and lowering the cost of the packaging.

As shown in FIGS. 8C and 8D, because of the economized space for shipping box 802, packaging of the portable pedestal electric heater 100 of the present invention on pallet 804 and in container 806 is also economized. Furthermore, the number of units capable of transportation in shipping container 806 as shown in FIG. 8D is maximized. These shipping advantages yield a lower cost of transportation and a cost advantage for the manufacturer and the consumer.

FIG. 9A shows yet another exemplary embodiment of portable pedestal electric heater 900 with support riser 930. Support riser 930 can be a unitary part or constructed of more than one piece assembled together. Support riser 930 achieves the designed dimension CE as defined by the distance from the vertical center of outlet opening 104 to the bottom of support riser 930 and the stability that support riser 130, (comprised of riser 132 and base 134) achieved in previously described embodiments. FIGS. 9B and 9C illustrate the packaging of portable pedestal electric heater 900 in a non-operating configuration, wherein housing 102 is separated from support riser 930. In this example housing 102 has the ability to fit within support riser 930. Shipping box 902 is therefore able to economize the space necessary to transport portable pedestal electric heater 900, thus using less packaging materials and lowering the cost of the packaging.

FIG. 10A shows yet another exemplary embodiment of portable pedestal electric heater 1000 with support riser 1030. Support riser 1030 in this example is comprised of support column 1032 and base 1034. Support column 1032 may be a unitary part of housing 102 or a separate part assembled to housing 102. Support riser 1030 achieves the designed dimension CE as defined by the distance from the vertical center of outlet opening 104 to the bottom of support riser 1030 and the stability that support riser 130, (comprised of riser 132 and base 134) achieved in previously described embodiments. FIGS. 10B and 10C illustrate the packaging of portable pedestal electric heater 1000 in a non-operating configuration, wherein base 1034 is separated from support column 1032. In this example housing 102 and support column 1032 are shipped to a customer as a unitary part or assembled together. Although shipping box 1002 does not economize space as well as previous examples, it does require less assembly for the end user.

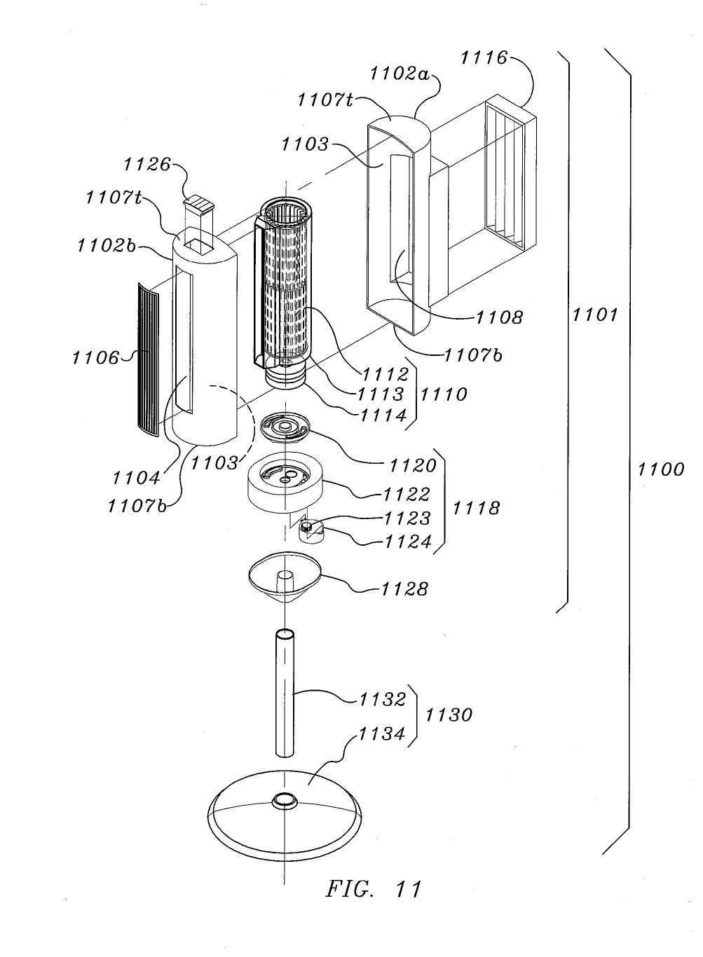

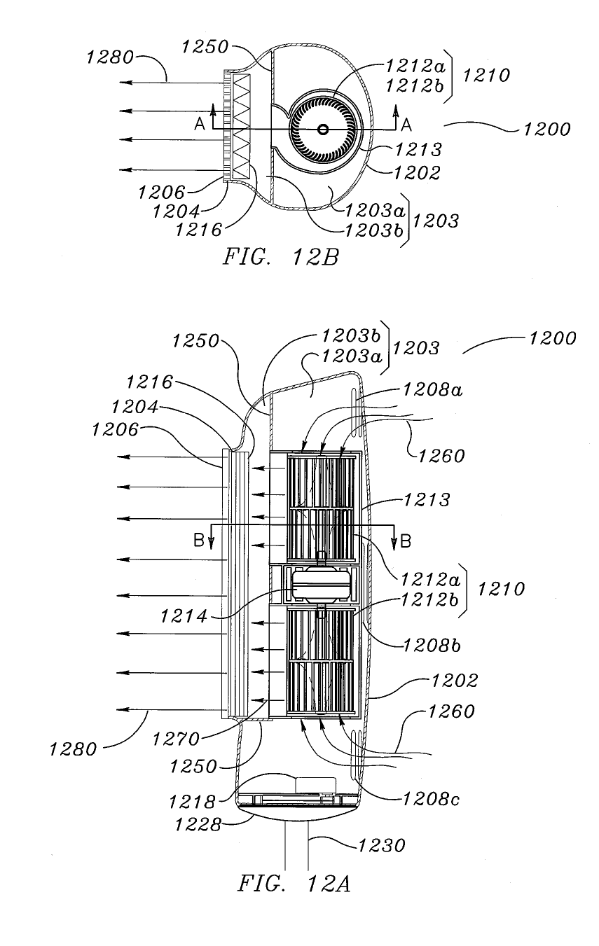

FIG. 11 shows an exploded perspective view of portable pedestal air filtering device 1100. As shown in FIG. 11, filtered air generation head 1101 is mounted to support column 1130.

As shown in the exemplary embodiment depicted in FIG. 11, housing 1102 may be constructed of more than one component, such as, for example, two halves 1102a, 1102b that may be assembled together. Housing 1102 has at least one air inlet opening 1108 and an air outlet opening 1104. Air outlet opening 1104 may be, for example as shown in FIG. 11, elongate and aligned with the longitudinal length of housing 1102 of portable pedestal air filtering device 1100.

As shown, at least one air blower 1110 may be disposed within interior space 1103 of housing 1102. Air blower 1110 may include at least one motor 1114 and at least one air impeller 1112 connected to motor 1114. Air blower 1110 may also include, as in this example, blower housing 1113 and other components (not shown). In one embodiment, air blower 1110 is a centrifugal type blower. It is contemplated that other types of blowers or fans may be used, such as for example, transverse type blowers or axial type fan.

Also shown is filter element 1116 disposed proximate air inlet opening 1108. Preferably, substantially all of the air being drawn into interior space 1103 by air blower 1110 flows through filter element 1116. It is contemplated that a portion of the air being drawn into interior space 1103 by air blower 1110 may bypass filter element 11 16. Such a bypass may be used to allow air pressure measurement used, for example, to monitor the state and condition of filter element 1116.

As shown in FIG. 11, in one embodiment filter element 1116 may include an elongate filter element that is aligned with the longitudinal length of housing 1102. In another embodiment, air inlet opening 1108 also includes an elongate construction and the elongate filter element 1116 extends substantially the length of the air inlet opening 1108. Use of an elongate element 1116 in conjunction with an elongate air inlet opening 1108 further allows the filtered exhaust air stream to be elevated above a support surface.

It is contemplated that filter element 1116 could be various types, such as for example, mechanical, electrostatic, carbon impregnated and the like. Preferably, the size of filter element 1116 would conform to standard filter dimensions commonly found at retail outlets.

The rotation of air impeller 1112 causes air to be drawn into housing 1102 through air inlet opening 1108. The air flow passes through filter element 1116 and subsequently through blower 1110, and exits housing 1102 through air outlet opening 1104. As the air flow passed through filter element 1116, airborne particles, such as for example, dust, pollen, dander, odors and the like are removed from the air flow.

Preferably, protective grill 1106 is located proximate air outlet opening 1104. Protective grill 1106 is preferably designed to minimize it's impedance of the air flow as it exits portable pedestal air filtering device 1100 while at the same time protecting portable pedestal air filtering device 1100 from the internal penetration of foreign objects.

In one exemplary embodiment, an intermediate coupler 1128 may be used to couple housing 1102 to support column 1130. Such a coupler 1128 may be either fixed or rotatable. Alternatively, housing 1102 may be coupled directly to support column 1130 such that housing 1102 is fixed with respect to support column 1130.

In another exemplary embodiment, housing 1102 rotates with respect to support column 1130. Such rotation may be accomplished either in an oscillatory fashion (over any angular range that may be desired), a stepwise positioning of housing 1102 (either manually or under automated control), or in a constant rotation, either in a clockwise or counter-clockwise direction. As shown, the mechanism for rotation may be located within or below housing 1102 and coupled between housing 1102 and support riser 1130. In yet another embodiment the rotation mechanism may be located between base 1134 and riser 1132 of support riser 1130.

As shown in FIG. 11, rotation/oscillation mechanism 1118 includes a motor 1124, gear 1123, oscillation plate 1120, and oscillation section 1122. It is contemplated that other rotating mechanisms, such as a link and pivot design, may be used to achieve rotation/oscillation movement.

As shown, support riser 1130 extends from housing 1102 and includes riser 1132 and base 1134. The upper portion of riser 1132 may be connected to coupler 1128 or housing 1102 and the lower portion of riser 1132 may be connected to base 1134.

Base 1134 sits on a support surface thus allowing the entire structure of portable pedestal air filtering device 1100 to be positioned in a substantially vertical, upright and elongate position.

Portable pedestal air filtering device 1100 may also include a controller, such as control assembly 1126 mounted, for example, on (or in the vicinity of ) top 1107t of housing 1102 for controlling one or more functions of the device, such as for example, the speed of blower 1110, the rotation or oscillation of the device, power on/off, etc.

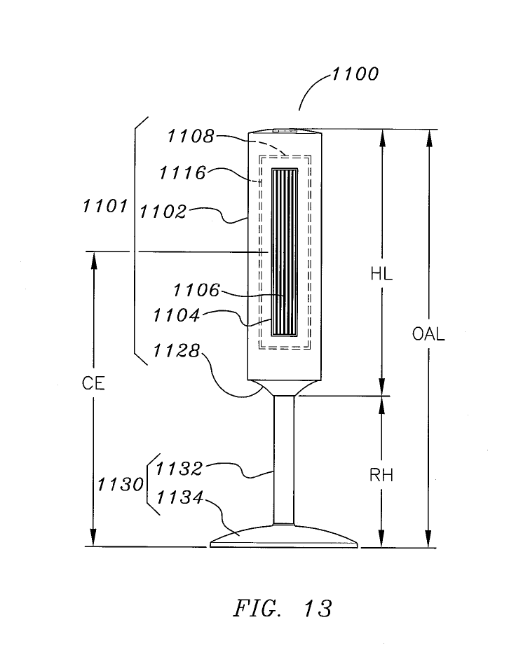

FIGS. 12A and 12B show vertical and horizontal cross sectional view through another embodiment of portable pedestal air filtering device 1200. FIG. 12B is a cross sectional view along plane “B-B” shown in FIG. 12A. FIG. 12A is a cross sectional view along plane “A-A” shown in FIG. 12B.

Housing 1202 defines interior space 1203. Interior space is partitioned in to intake portion 1203a and exhaust portion 1203b by segregation walls 1250. Blower 1210 is disposed within interior space 1203. Motor 1214 rotates impeller 1212a and 1212b drawing inlet air 1260 into intake portion 1203a via multiple inlet openings 1208a, 1208b and 1208c. Exhaust air stream 1270 is generated and exits blower housing 1213 subsequently entering exhaust portion 1203b. Exhaust air stream 1270 passes through filter element 1216 and exits housing 1202 via air outlet opening 1204 and protective grill 1106 as filtered exhaust air stream 1280.

Intermediate coupler 1228 may is used to couple housing 1202 to support column 1230. Rotation/oscillation mechanism 1218 is shown operationally coupled between column 1230 and housing 1202.

Segregation walls 1250 serve to increase the efficiency of portable pedestal air filtering device 1200. Segregation walls 1250 impede a recirculation of exhaust air stream 1270 into blower housing 1213 within interior space 1203 of housing 1202. This assures that the energy used by motor 1214 of blower 1210 is utilized to draw inlet air 1260 into the device. A greater quantity of ambient air passes through filter element 1216 over time, thus increasing the overall efficiency of the device.

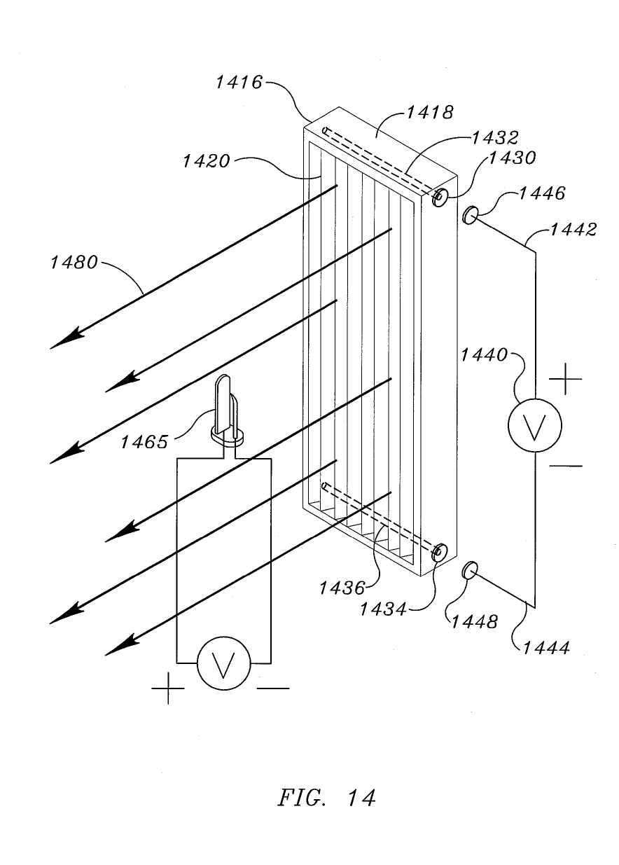

FIG. 13 shows various dimensional relationships of portable pedestal air filtration device 1100. As shown, dimension HL is the length or height of housing 1102 and dimension RH is the length or height of support riser 1130, which in this example is the combined length or height of base 1134 and riser 1132. Dimension OAL is defined by the length or height of portable pedestal air filtration device 1100 as measured from the bottom of support riser 1130 to top of housing 1102. Dimension CE is defined by the distance from the vertical center of air outlet opening 1104 to a surface of support riser 1130 which contacts a support surface.

In one embodiment rise height RH is greater than about 25% of dimension CE. In addition, in another embodiment rise height RH is greater than about 15% of overall length OAL of portable pedestal air filtration device 1100. In yet another embodiment, rise height RH is greater than about 16% of length HL of housing 1102. In yet another embodiment, rise height RH is greater than about 39% of length HL of housing 1102. In another embodiment, length HL of housing 1102 is less than about 85% of overall length OAL

In one embodiment dimension CE is greater than about 65% of overall length OAL. In yet another embodiment dimension CE is greater than about 70% of length HL.

In one exemplary embodiment dimension CE is preferably about 14 inches or greater. In another exemplary embodiment, rise height RH is at least about 3.5 inches or greater and may be adjustable as desired. Further, length HL of housing 1102 may preferably be between about 14 inches and about 50 inches, while the overall length OAL from the floor to the top of portable pedestal air filtration device 1100 is preferably about 18 inches or greater, and alternatively between about 18 inches to about 60 inches.

Elevating air inlet opening 1108 and air outlet opening 1104 above a support surface (e.g. floor) has several advantages not found in conventional air filters. The dimensional relationships of portable pedestal air filtration device 1100 elevate outlet opening 1104 above the support surface thereby reducing the possibility that the filtered exhaust air stream will disturbed to airborne such substances as dust, pollen or dander on the support surface. The above dimensional relationships of portable pedestal air filtration device 1100 also elevate air inlet opening 1108 above the support surface increases the possibility that airborne dust, pollen or dander will settle out of the air prior to passing through filter element 1116 and entering interior space 1103. This will increase the life of the filter or the time between filter maintenance. These dust and debris can be detrimental to, for example, respiratory conditions.

In other all other respects the advantages accorded to portable pedestal air filtration device 1100 are similar to the advantages described for portable pedestal electric heater 100 of FIGS. 4A and 4B.

FIG. 14 shows an embodiment of electrostatic filter 1416. Electrostatic filter 1416 includes filtration media 1420, frame 1418, contacts 1430, 1434 and interface conductors 1432, 1436.

Filtration media 1420 preferably minimally impedes the flow of air stream 1480 through the device. The greater the flow of air stream 1480 the greater the volume of air that can be filtered over time. The ability of filtration media 1420 to mechanically filter impurities may therefore be limited. The filtration ability can be increased by charging filtration media 1420 with an electrostatic charge. The embodiment illustrated in FIG. 14 provides increased particulate collection from a flowing gas (such as air stream 1480) by using the force of an induced electrostatic charge.

An electrostatic charge is induced in filter media 1420 through a potential differential applied to isolated areas proximate interface conductors 1432, 1436. As shown, interface conductors 1432 may be connected to the positive pole of voltage source 1440 via contact 1430, source contact 1446 and conductor 1442. As shown, interface conductors 1436 may be connected to the negative pole of voltage source 1440 via contact 1434, source contact 1448 and conductor 1444. Through the proper conditioning of the voltage supplied by voltage source 1440, filtration media 1420 can be charged either with a positive charge or a negative charge. It is contemplated that filter media 1420 may include electrically conductive materials and/or electrically non-conductive materials.

Air filtration can be further enhanced by the inclusion of corona discharge emitter 1465. As shown, corona discharge emitter 1465 is a variation of the “hot spark” coronal discharge method that is well known to one skilled in the art. In the exemplary embodiment shown, corona discharge emitter 1465 is designed to generate negative ions and filtration media 1420 is charged with a positive charge. Negative ions are air molecules that temporarily contain an extra electron, causing the entire molecule to possess a negative electrical charge.

The negatively charged air molecules exit, for example, portable pedestal air filtering device 1200 of FIG. 12 and enter the surrounding air. When such negatively charged air molecules encounter particulates they transfer the extra electron to the particulate thus negatively charging the particulate. When these particulates passed through positively charged filtration media 1420 along with air stream 1480 the negatively charged particulates attach themselves to filtration media 1420 in accordance with Coulomb's Law. As can be appreciated, the ability to negatively charge air stream 1480 and recirculate it through positively charged filter media 1420 can increase the filtration efficiency of electrostatic filter 1416 without impeding the flow of air by conventional mechanical filter means.

Although filtration media 1420 is shown with an induced electrostatic charge by using voltage source 1440 the invention is not so limited. It is contemplated that electrostatic filter 1416 could be a permanently charged filter.

Referring now to FIG. 13 and FIG. 14, elevating filtered air generation head 1101 above a support surface (e.g. floor) has advantages when filtering air electrostatically. These advantages are not found in conventional air filter devices. The dimensional relationships of portable pedestal air filtration device 1100 reducing the possibility that the negatively charged air molecules of air stream 1480 will transfer the extra electron to the support surface prior to successfully transferring the extra electron to the particulate in the air. This increases the chance that more particulates in the air will be negatively charged thereby increasing the filtration efficiency of electrostatic filter 1416.

As can be appreciated elevating filtered air generation head 1101 above a support surface using support riser 1130 has several advantages not found in conventional air filter devices. Minimizing the disruption of such substances as dust, pollen or dander that have already settled onto the support surface and increased electrostatic filtration efficiency are readily apparent advantages. Such advantages contribute to the comfort of consumers, specifically those that suffer from, for example, respiratory conditions.

Although the invention has been described with reference to exemplary embodiments, it is not limited thereto. Rather, the appended claims should be construed to include other variants and embodiments of the invention, which may be made by those skilled in the art without departing from the true spirit and scope of the present invention.

What is claimed:

1. A portable pedestal air filtering apparatus for providing a filtered exhaust air stream at an elevation above a support surface, said apparatus comprising:
a filtered air generation head comprising:
an elongate housing having at least one sidewall, a top end, a bottom end, and a longitudinal length extending substantially upward from said bottom end to said top end;
an interior space within said elongate housing;
an inlet opening in said elongate housing allowing air to enter said interior space;
an air blower disposed within said interior space for receiving said air, said air blower comprising:
an air impeller;
a motor for rotating said air impeller to generate an exhaust air stream;
an air outlet opening in said elongate housing allowing said air to exit said interior space;
a filter element disposed such that substantially all of said air passing through said interior space passes through said filter element;
a filtered exhaust air stream projected from said interior space of said elongate housing via said air outlet opening;
a support riser for supporting said filtered air generation head at an elevation above a support surface, said support riser comprising:
a base in contact with said support surface;
a riser having a longitudinal length extending substantially upward from said base, said riser comprising:
a first end connected to said base;
a second end connected to said elongate housing; and
an elevation of said filtered exhaust air stream defined by a distance from where said support riser contacts said support surface to a vertical midpoint of said air outlet opening of said filtered air generation head.

2. The portable pedestal air filtering apparatus of claim 1, wherein said filter element is disposed to filter said air prior to passing said air through said impeller.

3. The portable pedestal air filtering apparatus of claim 1, wherein said filter element is disposed to filter said exhaust air stream generated by said air impeller.

4. The portable pedestal air filtering apparatus of claim 1, further comprising an ion generator disposed within a flow of said exhaust air stream.

5. The portable pedestal air filtering apparatus of claim 1, wherein said filter element further comprises an electrostatic filter element.

6. The portable pedestal air filtering apparatus of claim 5, wherein said electrostatic filter element is a permanently charged electrostatic filter element.

7. The portable pedestal air filtering apparatus of claim 5, further comprising an electrical contact wherein said electrical contact is utilized to induce an electrostatic charge in said electrostatic filter element.

8. The portable pedestal air filtering apparatus of claim 1, further comprising a segregation wall, wherein said segregation wall segregates said interior space into an intake portion and an exhaust portion.

9. The portable pedestal air filtering apparatus of claim 8, wherein said filter element is disposed in said exhaust portion.

10. The portable pedestal air filtering apparatus of claim 8, wherein said filter element is disposed in said intake portion.

11. A portable pedestal air filtering apparatus comprising:
a filtered air generation head comprising
an elongate housing comprising:
a wall portion having a predetermined length HL, wherein said length HL of said elongate housing is oriented substantially vertically;
an inlet opening formed in a first portion of said wall portion;
a vertically elongate outlet opening formed in a second portion of said wall portion, and;
an air generator disposed within said elongate housing and positioned between said inlet opening and said vertically elongate outlet opening, said air generator inducing a flow of inlet air to enter said elongate housing through said inlet opening and generating a flow of exhaust air that exits said elongate housing through said elongate outlet opening, said air generator further comprising:
a motor comprising at least one shaft extension;
an air impeller attached to said shaft extension;
an axis of rotation of said air impeller oriented in a substantially vertical orientation;
a filter element disposed such that substantially all of the air passing through said elongate housing passes through said filter element;
a support member providing support and elevation for said elongate housing, said support member comprising;
a base contacting a support surface;
a column supported by said base and extending vertically upward relative to said support surface and operatively connected to the elongate housing at the opposing elevated end of said column; and
a predetermined rise height RH of said support member measured from the support surface to said opposing elevated end of said column;
wherein said rise height RH of said support member and said length HL of said elongate housing are utilized to elevate said filtered exhaust air above said support surface, wherein said rise height RH is greater than about 16% of said length HL of said elongate housing.

12. The portable pedestal air filtering apparatus of claim 11, wherein said filter element is disposed to filter said flow of inlet air prior to passing through said impeller.

13. The portable pedestal air filtering apparatus of claim 11, wherein said filter element is disposed to filter said flow of exhaust air subsequent to passing through said impeller.

14. The portable pedestal air filtering apparatus of claim 11, further comprising an ion generator disposed within said flow of exhaust air.

15. The portable pedestal air filtering apparatus of claim 11, wherein said filter element further comprises an electrostatic filter element.

16. The portable pedestal air filtering apparatus of claim 15, wherein said electrostatic filter element is a permanently charged electrostatic filter element.

17. The portable pedestal air filtering apparatus of claim 15, further comprising an electrical contact wherein said electrical contact is utilized to induce an electrostatic charge in said electrostatic filter element.

18. A method for elevating a vertically oriented column of filtered exhaust air above a support surface comprising the steps of:
contacting a support surface using a base;
extending a riser vertically upward from said base to a distal end;
connecting an elongate housing to said distal end of said riser such that a longitudinal length of said elongate housing is oriented substantially vertically;
disposing an air blower within an internal space of said elongate housing between an air inlet and a vertically elongate air outlet;
inducing an air flow into said air inlet by rotating said air blower;
generating an exhaust air flow out of said air outlet using said rotation of said air blower;
filtering substantially all of said air flow into said air inlet and/or said exhaust air flow; and
expelling said vertically oriented column of filtered air out of said interior space of said elongate housing at an elevation above said support surface;

19. A method for elevating a vertically oriented column of filtered exhaust air above a support surface of claim 18, further comprising introducing ions into said vertically oriented column of filtered air.

20. A method for elevating a vertically oriented column of filtered exhaust air above a support surface of claim 18, further comprising charging a filter element with an electrostatic charge.
